(19) United States
(12) Patent Application Publication
(10) Pub. No.: US 2017/0078456 A1
(43) Pub. Date: Mar. 16, 2017

(54) Remote SIP Stack and Architecture and Methods for Video Calls Between Mobile Devices

(71) Applicant: SIGHTCALL, INC., San Francisco, CA (US)

(72) Inventors: Frédéric Navare, Paris (FR); Sheffler Thomas, San Francisco, CA (US); Antoine Vervoort, Paris (FR); Thomas Cottereau, Millbrae, CA (US); Matthieu Piquet, Paris (FR)

(73) Assignee: SIGHTCALL, INC., San Francisco, CA (US)

(21) Appl. No.: 14/849,596

(22) Filed: Sep. 10, 2015

Related U.S. Application Data
(60) Provisional application No. 62/053,755, filed on Sep. 22, 2014.
(60) Provisional application No. 62/061,657, filed on Oct. 8, 2014.

(51) Int. Cl. H04L 29/06

(52) U.S. Cl. CPC H04L 69/08; H04L 65/1006; H04L 65/605; H04L 65/1083; H04L 65/403

(57) ABSTRACT

This disclosure describes computer architectures, software, and methods by which a custom signaling protocol is implemented for communicating between an app on a mobile device and an app that is either on a local area network or on a mobile device using a special-purpose cloud service. The cloud service translates messages from the mobile app protocol into SIP and also tracks the power state of the mobile app, and translates the SIP protocol back to the mobile app protocol when sending the signaling messages to the mobile app. The decentralized architecture maintains interoperability with SIP networks and presents an interface better suited to the needs of mobile apps. Additional embodiments provide computer architectures, software, and methods for transmitting audio-video data between mobile apps with changing IP addresses without the need to drop the call.

### CROSS REFERENCE TO RELATED APPLICATIONS

The present application is a continuation of and claims the benefit of U.S. Provisional Patent Application Ser. No. 62/053,755 filed Sep. 22, 2014 and U.S. Provisional Patent Application Ser. No. 62/061,657 filed Oct. 8, 2014. The foregoing applications are hereby incorporated by reference herein in their entirety.

### INCORPORATION BY REFERENCE

All publications and patent applications mentioned in this specification are herein incorporated by reference to the same extent as if each individual publication or patent application was specifically and individually indicated to be incorporated by reference.

### FIELD

This disclosure describes computer architectures, software, and methods by which a custom signaling protocol is implemented for communicating from a mobile device to another mobile or landline device using a special-purpose cloud service. The cloud service translates the custom protocol into SIP and also tracks the power state of the mobile app. and facilitates the transmission or transfer or audio/visual data between one mobile device to another or to a landline device. The decentralized architecture maintains interoperability with SIP networks and presents an interface better suited to the needs of mobile devices and apps.

### BACKGROUND

In internet-based telephony solutions, ‘signaling’ refers to the protocols and methods used for one terminal (a device or app) to request or accept a call with another terminal. The transmission of the ‘media’ (audio and video packets) is handled using a protocol different from that used for signaling.

Signaling and media present different challenges. Media packets must be delivered in near real-time or the human ear will detect audio latency. Signaling packets can tolerate more latency. While one would think that the real-time component of multimedia calling is the most difficult problem, as the number of devices in the network scales up, signaling presents a significant scaling problem, by many considered a more difficult problem than media latency. The introduction of mobile “apps” brings additional concerns.

An industry-standard signaling protocol, called Session Initiation Protocol (SIP), offers reliability and interoperability with the publicly switched telephone network (“PSTN”). This use of SIP in mobile apps is common today, but introduces scaling problems on the server side. Custom signaling protocols have been developed for mobile apps, but these do not have the benefits of interoperability to work with the PSTN.

Session initiation protocol (SIP) is the industry signaling standard today. In a SIP network a central SIP server maintains a database of registered terminals/devices 100. The database maps a name for each terminal/device 100 to its IP-address. Referring to FIG. 1, a terminal/device 100 registers to the SIP server 102 with a REGISTER command 104. This associates the name of the device with its current IP address in data base 106. The act of registering allows the SIP server 102 to know how to send messages (e.g., SIP specific for call signaling) to the terminal/device 100. A SIP server may be configured to transport messages to a terminal/device 100 via a transmission control protocol (“TCP”) or a user datagram protocol (“UDP”). If TCP is chosen to transport messages, then an active connection will remain open from the SIP server to each terminal/device 100, where each connection utilizes resources on the CPU and memory of the SIP server to register the terminal/device 100. With UDP only the address of the terminal/device 100 must be retained and fewer resources are used by the SIP server to register terminal/device 100. The choice of TCP or UDP impacts the scalability of the SIP server. Protocol other than UDP, as will be appreciated by the skilled artisan, lowering SIP server resource requirements may also be used in place of UDP, or ones that may be developed in the future.

Referring to FIG. 2, in a typical SIP call a series of exemplary messages are that may be transported/exchanged between the terminals/devices 100A/100B (for example) and the SIP server 102. The skilled artisan will understand these messages, thus for brevity the process is describe only in general terms. The SIP server is involved in transporting/relaying each message (e.g., INVITE sent to called party beginning the sequence, RINGING indicating state of call on receiving terminal 100B, or OK indicating receiving terminal 100B answered call etc.). Since the SIP server 102 is a centralized resource used by many terminals/devices 100 for many calls, its performance and scalability are important. If SIP server 102 becomes overwhelmed, all devices and calls in the network can be affected.

The main benefit of using SIP is that it is an industry standard providing interoperability to a large number of service providers. Using SIP it is possible to route calls to the PSTN using SIP trunking Because SIP is a mature standard, it provides capabilities for advanced features like “3-way Call Join,” among others.

SIP evolved in a time when most devices were continuously connected to the network and were permanently powered on, e.g., landlines. These assumptions are not necessarily true for a mobile device or mobile app. A mobile device as distinguished from a mobile app running on the mobile device is that the device may be continuously connected to the network, whereas an app running on the mobile device may enter a different power state (e.g., standby, sleep, halted etc.).

A mobile device commonly moves or hops from one network to another, e.g., between cell towers or between WiFi networks. With each hop the app running on the device receives a new IP-address. Mobile apps can be developed that communicate this information directly to the SIP server. As the app notices the changed IP-address it may unregister the current IP-address and then REGISTER a new one, referring back to FIG. 1. However, for a large number of mobile apps, each hopping and getting a new IP-address, the number of messages transported/transmitted to the SIP server simply for the registration function may overwhelm the SIP server and certainly makes it much less efficient.

Apps running on mobile devices move through many different power states in order to preserve battery life. An app may be in the foreground when it is the direct focus of user interaction, may be put in the background as the user moves to a different task, or may enter a powerdown state when the user is not using the device. When an app is in the background, powerdown or the mobile device is powered off, it may be the case that the app cannot receive messages from the SIP server.

A mobile app may be a direct client of a SIP server, and many such VOIP apps exist in the app stores today. As a non-limiting example, Apple, Inc. anticipates VOIP apps by providing special compilation flags for the developer to use. A VOIP app receives special background handling and can be woken up by a remote command. However, this option is only available via a TCP connection to a server.

If a SIP server is configured to use TCP connections, then the transporting/relaying of an INVITE message (for example) from the SIP server to a sleeping mobile device (e.g., iPhone or iDevice) can wake the sleeping VOIP app. This solution suffers from the fact that TCP connections are expensive. The SIP server is a resource, and oftentimes a bottleneck in the system. It is undesirable to configure the SIP server to keep TCP connections open to each device registered with it, when a UDP connection is preferable.

Referring to FIG. 3, in many systems today mobile apps are deployed that communicate via SIP transported over TCP directly to a SIP server on the internet. As stated earlier, this arrangement has the following problems with respect to mobile devices.
In order to support “wake” functionality, the server must maintain a TCP connection to each connected terminal, which is expensive.
As devices roam, app IP addresses change. The volume of “registration” messages can overwhelm the SIP server and degrade its functionality, sometimes significantly or catastrophically.

Referring now to FIGS. 4-6 an overview of prior art two-way video and audio calls now common over the internet is provided, which is the transfer of actual audio/visual data as distinguished from registration of a terminal/device/app described above. Much of the development of video call technology occurred when computers or devices for each party remained stationary and permanently tied to a local network. The experience of users in this stationary configuration has shaped the expectations of users today, even as they move to mobile devices.

Video calls on mobile devices pose an extra set of challenges, in addition to the signaling challenges described above that must be overcome to provide reliable service.
A mobile device may switch between networks. A mobile device may transition from 3G/4G to WiFi and back again, or switch between cell towers. Each time a device switches a network, the IP address of the app running on it changes.
People expect mobile devices to hop between networks with no interruption in service in accordance to expectations from stationary devices, expecting an ongoing call to switch networks seamlessly. The implementation challenge to this expectation is that the IP address of the mobile device may change during such a hop.
Mobile devices present battery usage and power constraints that require app developers to manage multiple power states. An app may be in the foreground, it may be in the background or it may be asleep. Mode transitions between these states conspire to make it difficult to keep a mobile device attached to a mobile call session.

Referring to FIGS. 4-6, the specifications for WebRTC provide STUN server 400 (FIG. 4) and TURN server 600 (FIG. 6) to facilitate video calls between apps running on two devices/terminals 402A and 402B or 602A and 602B. These servers are sufficient to establish audio and video media transfer between two endpoints (e.g., apps running on devices 402A and 402B), but are not sufficient to maintain a seamless call experience between two mobile devices as the mobile devices switch networks (e.g., device hops between cell towers or WiFi networks) and respond to power-state transitions. WebRTC defines three main modes in which an endpoint may be discovered: (i) peer-to-peer; (ii) STUN server; and (iii) TURN server.

In peer-to-peer connections (not shown), the IP-address of the endpoint can be reached directly. In today's networks, this situation only occurs when two endpoints are on the same local area network. If the IP address of either party changes, then a new call must be negotiated. WebRTC does not address how this happens.

A STUN server 400 (FIGS. 4-5) is an intermediary that helps establish peer-to-peer media flow between two terminals/devices 400A and 400B that may be behind firewalls. To get the media going, each app running on the terminal/device (e.g., 400A and 400B) contacts the STUN server 400, where the IP address information is exchanged. The STUN server 400 assists in opening a “hole” in the firewall at each terminal/device (e.g., 400A and 400B). In fact, the hole opened in each firewall is a hole that only allows traffic from the other terminal/device (e.g., 400A and 400B). Once the media from the two terminals/devices begins flowing, the STUN server 400 drops out of the negotiation and the apps on the two terminals/devices (e.g., 400A and 400B) communicate in a peer-to-peer fashion. The STUN 400 server (FIGS. 4-5) only helps set up the initial media flow. If the IP address of either app on the terminal/device changes, the other device cannot know the new IP address of the first device, and the call or media transfer is dropped. The STUN server 400 does not resolve the situation where either of the apps running on the two devices changes locations or IP addresses, and media transfer (the call) is dropped. Further, the STUN server 400 does not have knowledge of power-mode transitions of either app on the respective terminal/device. If one party puts its app in the background, the other party/app will only know that there is no more media arriving from the first party.

Referring to FIG. 6, a TURN server 600 relays all audio and video media between two parties that cannot send media directly to one another in a peer-to-peer fashion, even with the help of a STUN server. TURN server 600 copies each media packet from its source (e.g., app on terminal/device 602A) to its destination (e.g., app on terminal/device 602B). If the IP address of either party changes, TURN server 600 cannot know the new IP address and the call is dropped. Thus, like STUN server 400, TURN server 600 does not resolve the situation where either of the two apps running on the terminals/devices changes locations or IP addresses, and in such circumstances will not allow media to transfer. TURN server 600, like the STUN server 400, cannot know the power state of an app, e.g., if an app goes in the background, TURN server 600 knows only that media has stopped flowing. Turn server 600 may or may not assume the call has dropped. Nothing in the TURN server specification addresses how one app knows the power state of another app.

This disclosure presents a system architecture for mobile video call apps that helps resolve scalability of signaling and the seamless flow of media packets between terminals/devices when these devices move between cell or WiFi stations changing IP addresses of apps or when power states of the apps change.

### BRIEF DESCRIPTION OF THE DRAWINGS

The inventive body of work will be readily understood by referring to the following detailed description in conjunction with the accompanying drawings, in which:

FIG. 1 depicts the prior art where a device registers to the SIP server with a REGISTER command;

FIG. 2 depicts a typical prior art SIP registration, where a series of messages are exchanged between the terminals and the SIP server;

FIG. 3 depicts prior art architecture for mobile apps communicating directly via direct connection to a SIP server over the internet;

FIG. 4 depicts prior art use of STUN server to open communication between two mobile devices;

FIG. 5 depicts prior art communication between two mobile devices after STUN server is dropped from communication;

FIG. 6 depicts prior art use of TURN server to open and maintain communication between two mobile devices;

FIGS. 7A-7C depict an architecture and methods for registering mobile devices via an agent server and the scalability afforded by such in accordance with an embodiment of the present invention; and

FIGS. 8A-8B depict and architecture and method to facilitate transfer of audio/visual data packets between mobile devices even when mobile devices hop networks in accordance with an embodiment of the present invention.

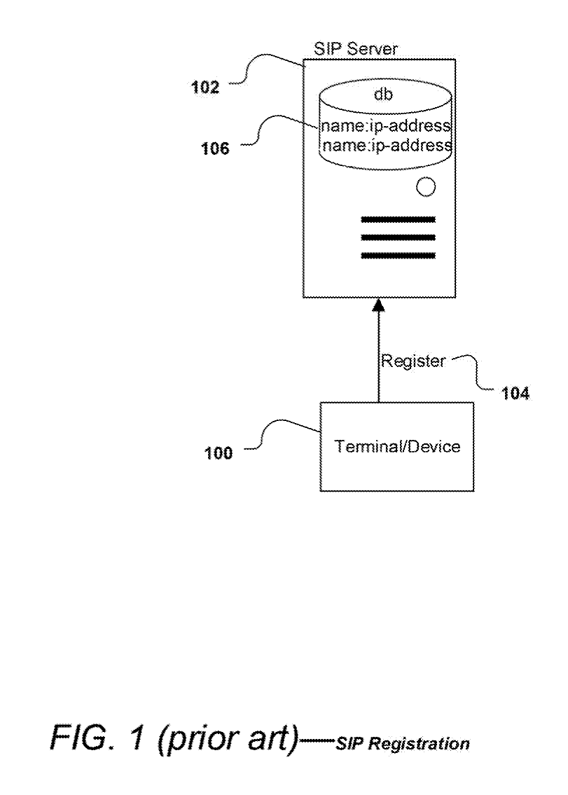

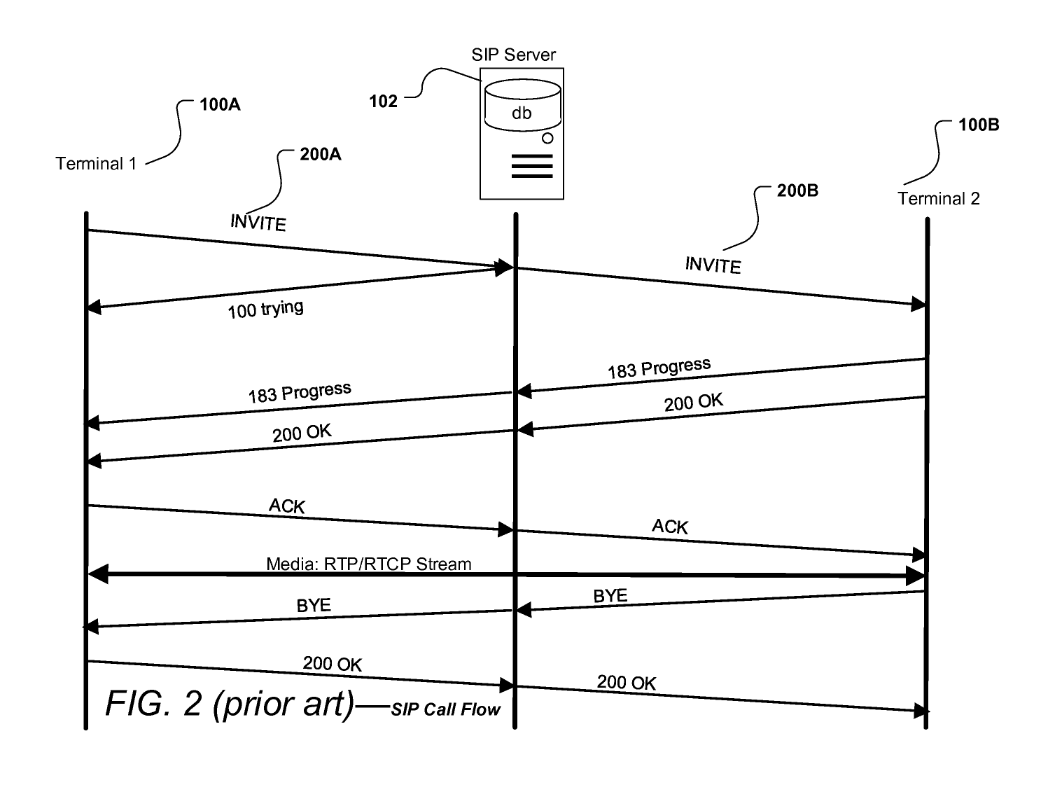

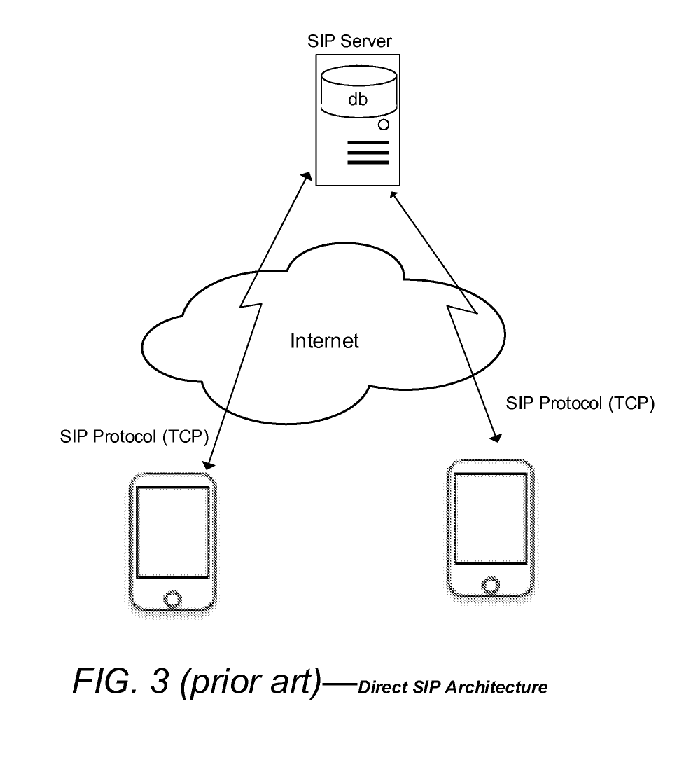

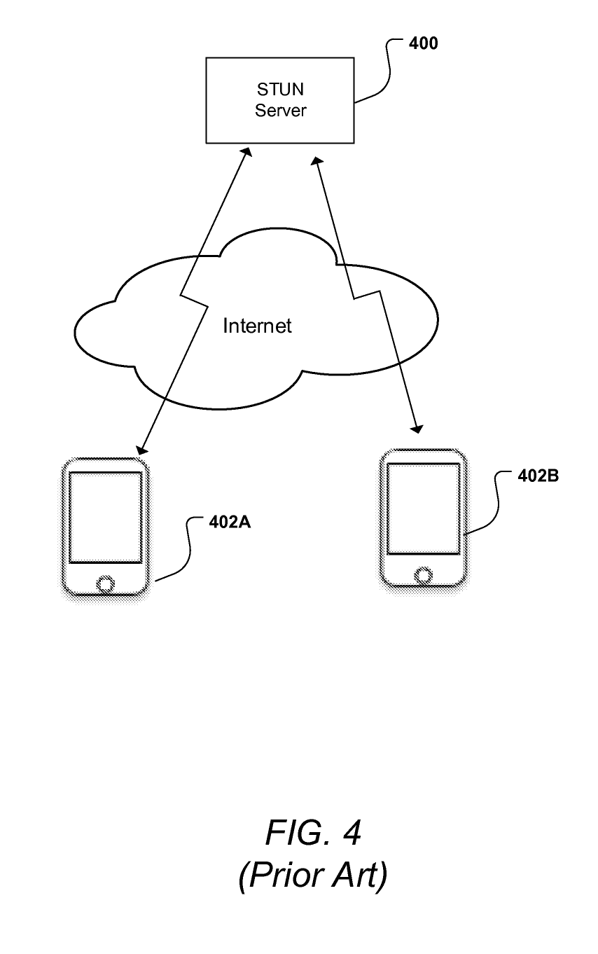

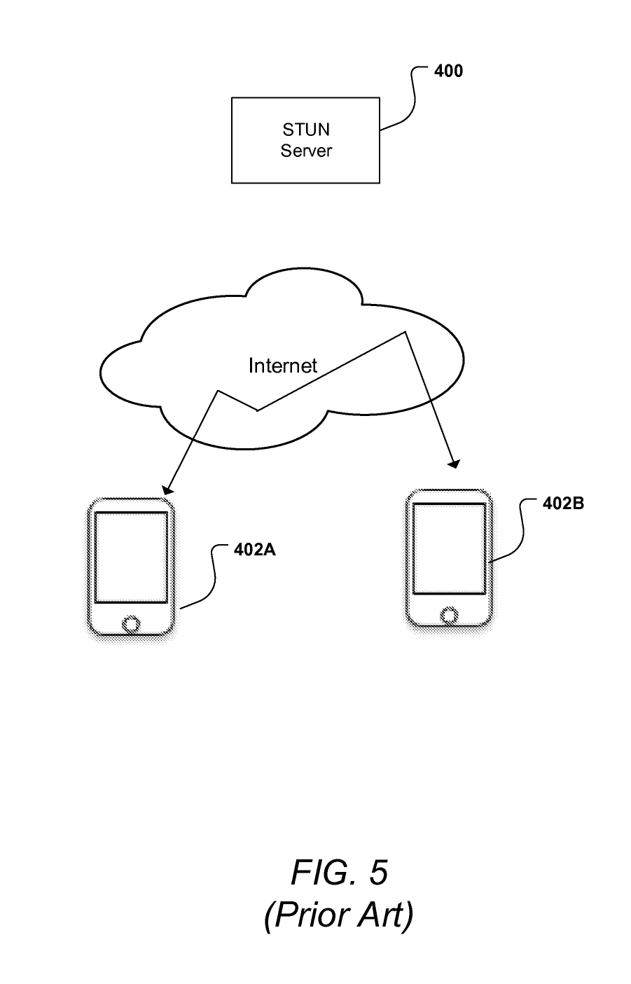

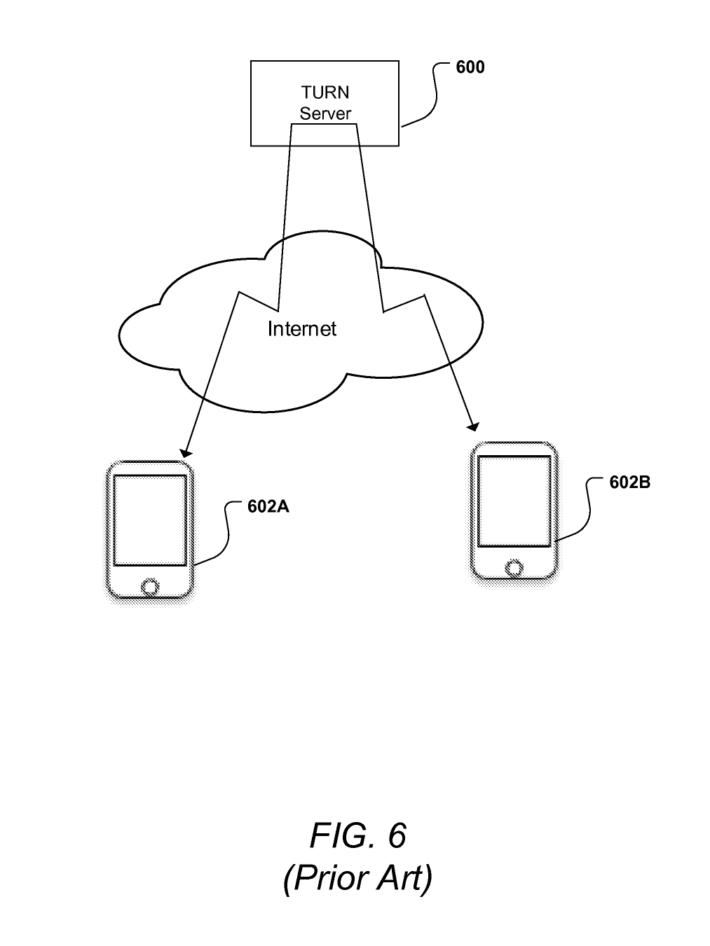

### DETAILED DESCRIPTION

A detailed description of the inventive body of work is provided below. While several embodiments are described, it should be understood that the inventive body of work is not limited to any one embodiment, but instead encompasses numerous alternatives, modifications, and equivalents. In addition, while numerous specific details are set forth in the following description in order to provide a thorough understanding of the inventive body of work, some embodiments can be practiced without some or all of these details. Moreover, for the purpose of clarity, certain technical material that is known in the related art has not been described in detail in order to avoid unnecessarily obscuring the inventive body of work.

An “app” or “mobile app” in the context of this applications means a software application specifically developed to run on a mobile device (e.g., phone, tablet, portable computer etc.) using a software development kit provided by the mobile operating system developers (e.g., Google® or Apple®).

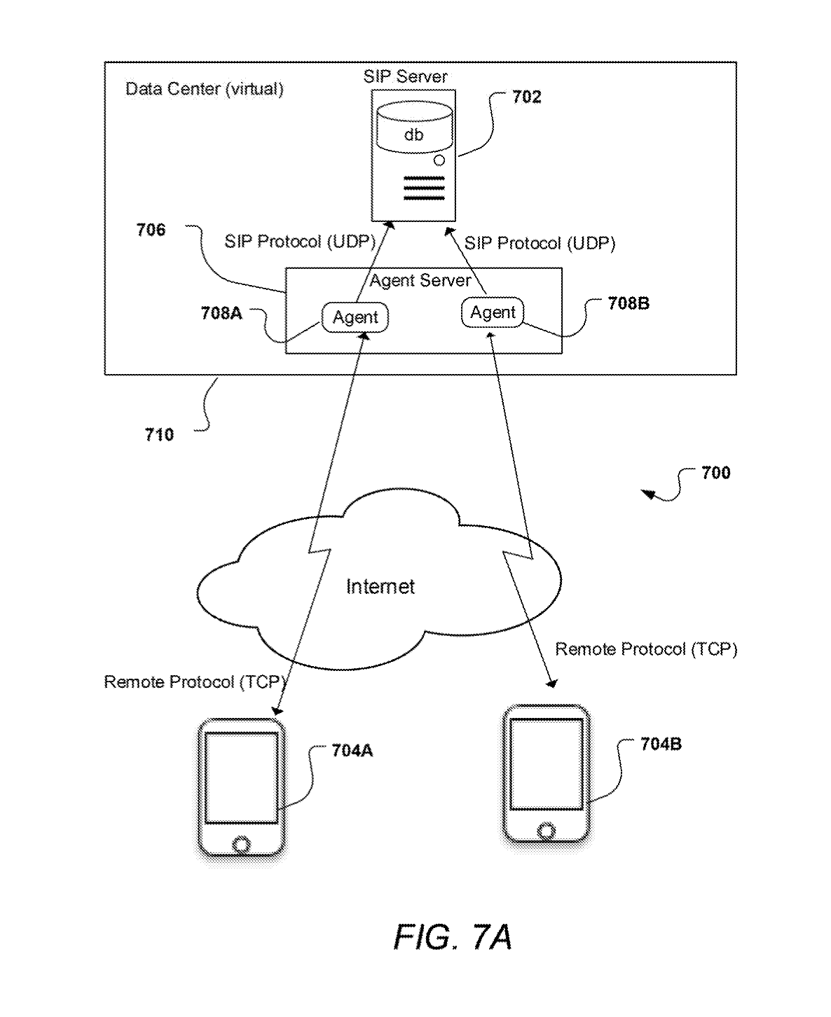

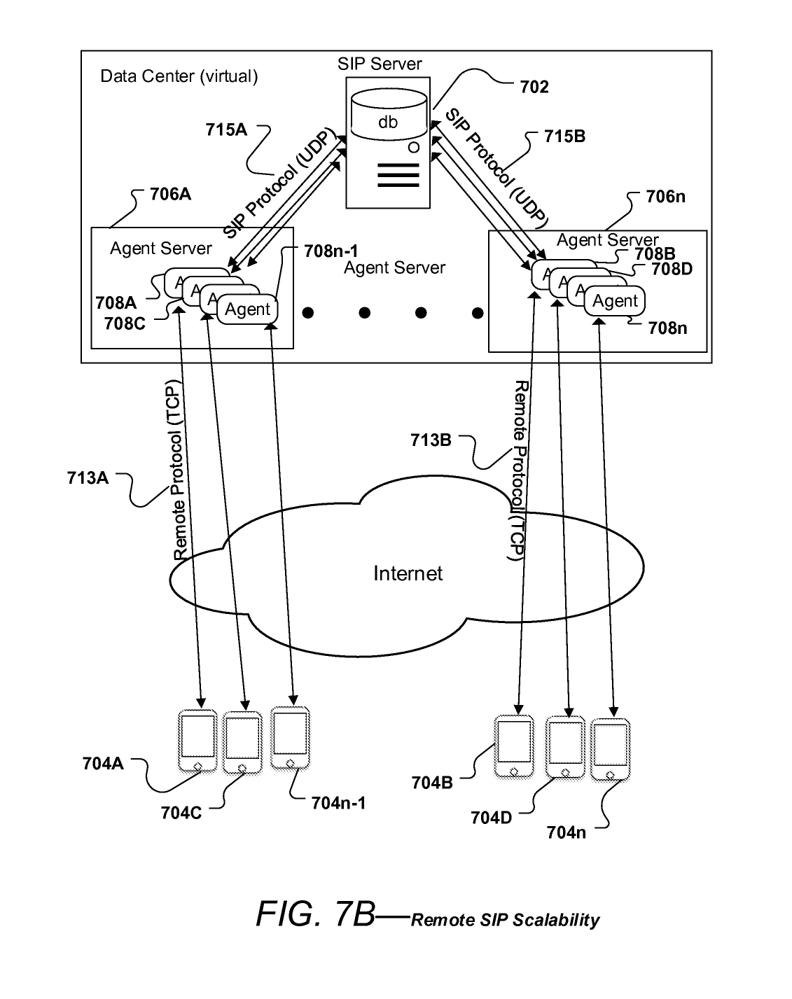

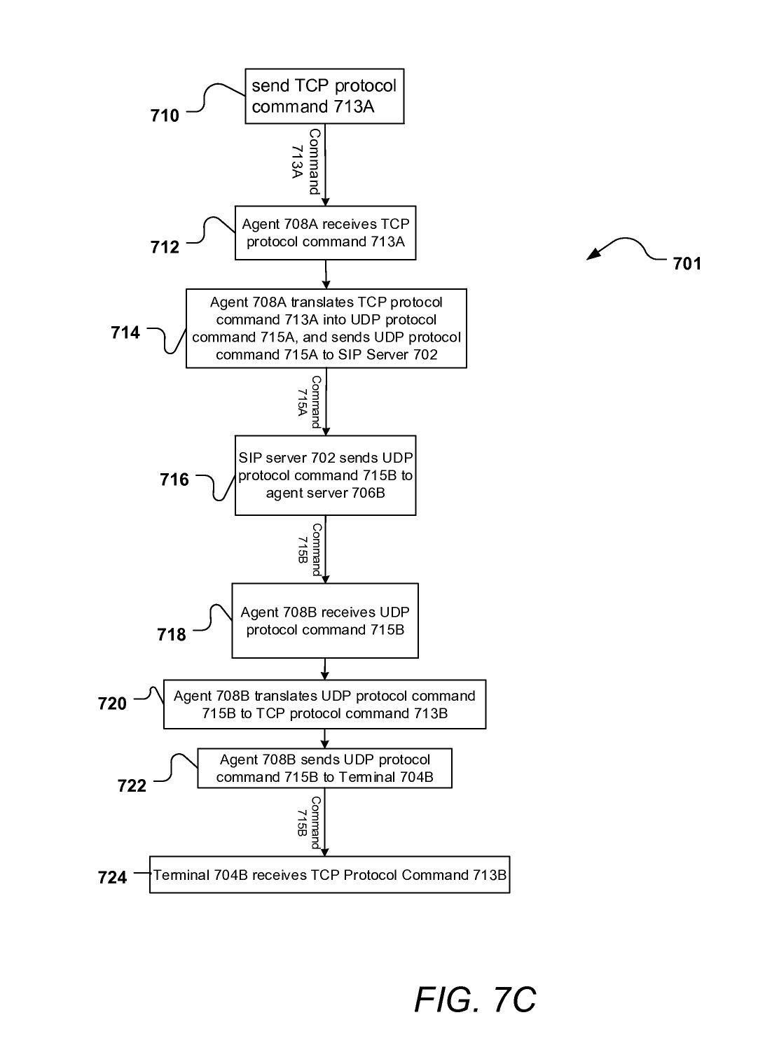

Referring to FIG. 7A, an architecture 700, in accordance with one embodiment, is provided to reduce the load placed on SIP server 702 when an app running on mobile terminals/devices 704 with changing IP addresses registers with SIP server 702. It is understood that the mobile terminals/devices, as used in this specification, means at least one mobile device having an app running on it, where the IP address of the app changes as described herein, and where the other terminal/device 704 may be a device on a local network, or likewise an app running on a mobile device also with a changing IP address; “terminals/devices” is used for simplicity of discussion. For the sake of clarity, embodiments of the present invention may be implemented using at least one app on a mobile device/terminal with a changing IP address, where the other may be a stationary device/terminal on a local network with a constant IP address or an app on the device/terminal with a changing IP address, like the first app. Agent server 706 is placed between terminals/devices 704 as a quasi-buffer to track terminals/devices 704. Agent server 706 may provide as many agents 708 to match the number of terminal/devices 704 needing to register with SIP server 702. Traditional SIP protocol transported over the less expensive UDP is used between each agent 706 and SIP server 702. Each agent 706 tracks exactly one mobile app (terminal/device 704) and maintains an open TCP connection between each mobile app (terminal/device 704) and agent server 706, where the TCP connection permits agent 708 to wake the mobile app, track its power status, and monitor the IP address as the device hops between networks. Agent server 706 permits the benefits of registering terminals/devices 704 with the expensive TCP connection with all its benefits, while maintaining the less expensive UDP connection with SIP server 702, thereby improving the capacity and performance of the SIP server to handle registering more mobile devices hopping between networks. As previously mentioned, the skilled artisan will appreciate that one of the device/terminals may be mobile while the other is either stationary or mobile.

The agent 708 is deployed in agent server 706 as a cloud server in this embodiment, and it has a persistent IP address. When the terminal/device 704 (e.g., mobile app) and the SIP server 702 need to communicate, the agent 708 acts as a relay and translator. In one embodiment, as messages flow from the SIP server 702 to the terminal/device 704 (e.g, mobile app), the IP address of the agent 708 is replaced with the actual current IP address of the terminal/device 704 (e.g, mobile app), as seen from the agent 708. As messages flow from the terminal/device 704 (e.g., mobile app) to the SIP server 702 (to initiate a call, for example), the agent 708 replaces its IP address in the messages with the actual IP address of the SIP server 702. In this way, the SIP server 702 does not need to know or be aware of the ever changing IP address of the terminal/device 704 (e.g., mobile app), which is now the job of the agent 708. As will be appreciated by the skilled artisan, the agent 708 may note the IP address of the mobile app through direct protocol commands or by observing the IP address of arriving packets. The agent 708 is instrumented to track the foreground/background power state of the mobile app as well. As the app awakens and sleeps it sends messages to the agent 708.

The distributed agent architecture in this embodiment of the present invention relieves pressure on the SIP server 702, which is asked only to do what it was designed to do: set up calls between terminals (e.g., mobile device/app 704). The SIP server 702 does not need to use the more expensive TCP transport protocol to communicate with each agent 708, since it is not being asked to wake sleeping apps. The wake function is the role of the agent 708 that uses the more expensive TCP protocol.

FIG. 7B illustrates how the architecture 700 scales. As more mobile devices/apps are added to the system, additional agent servers 706 can be deployed to handle the load of many mobile devices/apps 704 trying to register with SIP server. The role of agent servers 706 is to keep an open TCP connection to each mobile device/app 704 and to translate remote-SIP protocol over TCP from mobile device/app 704 into the native SIP over UDP protocol of the SIP server 702. With this arrangement the SIP server 702 can scale to handle many more instances of mobile device/app clients 704 than if each mobile device/app connected directly to the SIP server. In this embodiment, each instance of the agent server 706A-n can host a finite number of agents 704, where scalability is achieved by instantiating additional agent servers.

Referring to FIG. 7C, in conjunction with FIG. 7B, a process 701 is shown for registering terminals (e.g., mobile device/app 704A and 704B) with SIP server 702 and architecture 700, in accordance with one embodiment. In step 710 a first terminal 704A (e.g. a first mobile device/app) sends command 713A (e.g. invite command) transported by TCP. In step 712 agent 708A of agent server 706A receives command 713A over TCP. In step 714, agent 708, while maintaining TCP connection with the first terminal 704A, translates the TCP protocol command 713A into UDP protocol command 715A and transports/sends command 715A to SIP server 702 over UDP, the less expensive and standard SIP protocol. In step 716, SIP server 702 sends/transports command 715B (the corresponding outgoing command 715A) to agent server 706B (represented by agent server 706n) over UDP. In step 718 agent 708B of agent server 706B (represented by agent server 706n) receives command 715B over UDP, and while maintaining UDP protocol connection with SIP server 702, in step 720 translates command 715B to TCP protocol command 713B, and in step 722 sends/transports command 713B to terminal 704B (e.g. a second mobile device/app or a stationary device on a local area network) over TCP, which establishes a TCP protocol connection with terminal 704B, or in the event a TCP protocol connection with terminal 704B was already established, such connection is maintained. In step 724, terminal 704B receives command 713B transported over TCP. The process may be reversed, as will be appreciated by the skilled artisan, for terminal 704B to either return/transport a command or send/transport its own command over TCP.

As previously described, agent server 706 permits agent 708A-n to maintain a TCP protocol connection with terminals 704A-n, permitting the flexibility of agent server 706 and agents 708 of knowing ever changing IP addresses of mobile terminals 704 and their power states, while at the same time keeping a fixed IP address with and ability to communicate with the SIP server under the preferred and less expensive UDP protocol. The architecture and method of this embodiment has the significant benefit of shifting or buffering the TCP load of multiple connections between mobile terminals to the agent servers, thereby preserving the capacity of the SIP servers.

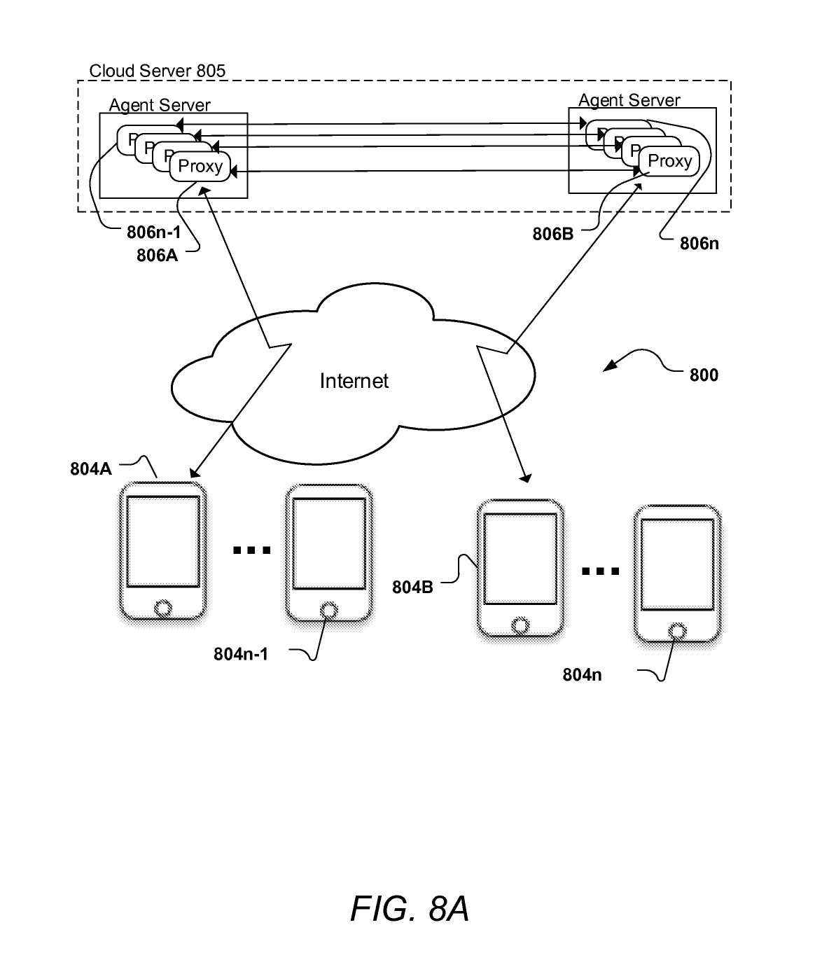

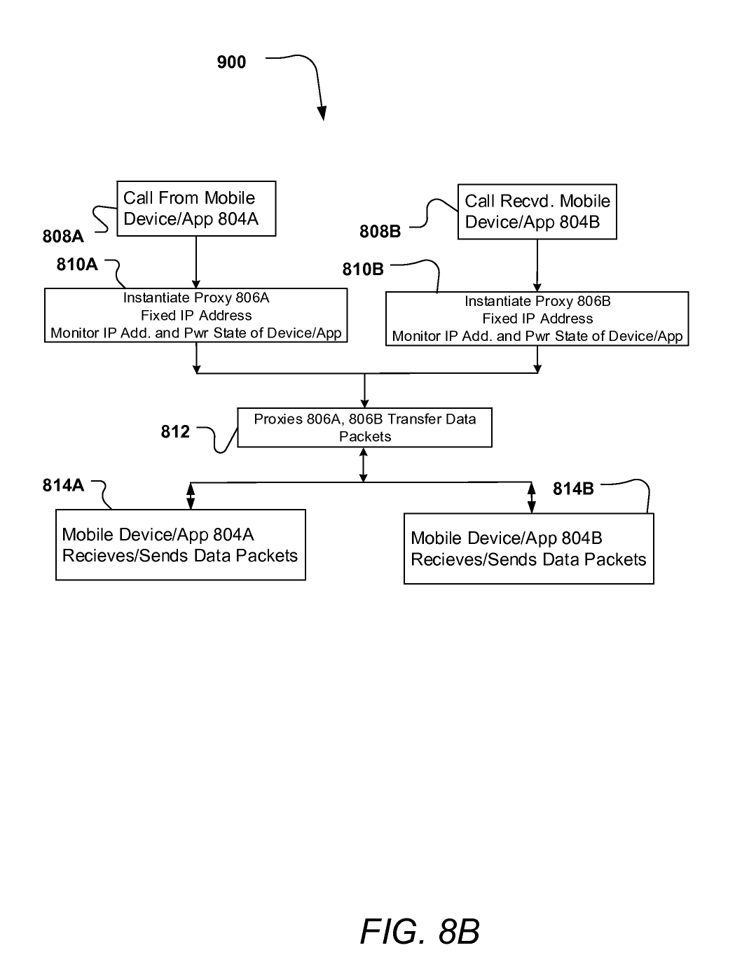

Referring to FIG. 8, this portion of the description uses “proxy” to distinguish from the use of “agent” above, but the skilled artisan will appreciate that “agent” and “proxy” are synonymous technically, but different words are used to facilitate description. Embodiments of the present invention provide a computer system architecture 800 and methods 900 in which each of two exemplary mobile device/app terminals 804A and 804B in a video or audio call are allocated a dedicated proxy 806A and 806B in a cloud server 805. As with the signaling embodiments described above, one app on a device may be mobile while the other is either mobile or stationary; both are described herein as being mobile to facilitate the description. Each proxy 806 monitors its mobile device/app's IP address (and power state), and facilitates media transfer between corresponding mobile device/apps 804 (e.g., 804A and 804B). As shown system architecture 800 and methods 900 are scalable for using multiple proxies, up to proxies 806n-1 and 806n and the corresponding terminals 804n-1 and 804n. For sake of brevity, this discussion refers to proxies 806A and 806B and terminals 804A and 804B, with the understanding that the description scales to a much larger number.

With continued reference to FIG. 8A, once mobile device/app 804A and 804B establishes a connection to corresponding proxies 806A and 806B, the mobile device/app can use the proxy as a fixed place to send information about its IP address and power state. The proxy may then facilitate audio and video media transfer between the two devices as described herein, functionally similar to that described for signaling. In an embodiment of the present invention, for each active instance of a mobile video (or audio) call from/to mobile device/app 804A, 804B a corresponding dedicated proxy 806A, 806B is instantiated on cloud server 805. The role of proxy 806 is to track the IP address and power state of mobile device/app 804. Proxies 806 run on cloud server 805, never sleep, and maintain a fixed IP-address. When mobile device/app 804A, 804B wants to send or receive media, it does so through its proxy 806A, 806B. If an agent instance has not been previously instantiated, an instance is started in cloud 805. Proxy 806A, 806B, in accordance with one embodiment, continuously track the IP address and power state of mobile device/app 804A, 804B through a specific protocol. Mobile device/app 804A, 804B is designed to be aware of proxy 806A, 806B, and reports updates of its IP-address and power state to the proxies. Each mobile device/app 804A, 804B sends its media through its proxy 806A, 806B, where it is routed to the appropriate endpoint, e.g., mobile device/app 804A, 804B in a two way call. This, of course, will also function if the devices are not mobile or if the mobile devices are stationary, though use of TURN or STUN servers may be more efficient.

Referring to FIG. 8B, in conjunction with FIG. 8A, a process 900 is shown for transferring data packets between terminals/apps where at least one IP address changes without terminating the call, which would happen if using a TURN server. In step 808A, 808B a call is made by mobile device/app 804A and received by mobile device/804B. In step 810A, 810B cloud server 805 instantiates proxy 806A, 806B each with a separate fixed IP address and each monitoring its corresponding mobile device/app's IP address and power state. In step 812 proxies 806A, 806B transfer data packets from or to either of the mobile device/apps 804A, 804B. In step 814A, 814B mobile device/apps 804A, 804B receive or send data packets, which are then transferred by proxies 806A, 806B until a user sends a signal to terminate the call. As previously explained, the proxies in cloud server 805 have a fixed IP address but each instance is assigned to a specific mobile device/app and tracks its IP address even if it changes and tracks its power state. In this manner the call can be seamlessly maintained even when IP addresses or power states change.

Fixing the IP addresses of proxies 806 has at least two benefits. Each mobile device/app 804 can reconnect to its proxy 806 as mobile device/apps 804A, 804B switches networks and IP addresses, but the IP addresses of proxies 806A, 806B remain fixed. Video and audio call data routed between proxies 806A, 806B is simplified and more reliable because both endpoints are in cloud 805 and have fixed IP addresses.

In straightforward alternative embodiments of the present invention, mobile to non-mobile scenarios may also be treated in a similar manner. In such a case, the mobile endpoint uses a proxy to relay its media in a manner as described above. The proxy may then participate in peer-to-peer, STUN-enabled or TURN-enabled communication with a WebRTC endpoint. In a multiparty conversation, each endpoint sends its media traffic to a conference bridge, or multipoint control unit (MCU). In embodiments of the present invention, each mobile application would send its data through its corresponding proxy, which would then connect to the MCU.

In summary certain features of embodiments of the present invention may include:
Avoid overwhelming the SIP server with REGISTER messages by partitioning the roaming function into an agent server;
One embodiment decentralizes the maintenance of active TCP connections away from the SIP server onto a separate cloud service allowing the mobile device/app to have its power state monitored by the active TCP connection;
Decentralization maintains TCP connections to each mobile device/app and translates messages to and from a SIP server using UDP packets for scaling efficiency
Decentralization can maintain a call even as a mobile device/app loses connectivity with the network or changes IP addresses, by regaining connectivity (at the same or different network, at the same or different IP address), in a manner that is transparent to the user.
Creating instances of proxies for each mobile device or endpoint permits fixing an IP address for each proxy, where media is transferred between proxies, and each proxy tracks the IP address of its endpoint (e.g., mobile device/app) which may change as the device moves; this permits continued media transfer via the proxies and monitoring of power states even as the endpoints change IP addresses.

While a number of exemplary embodiments, aspects and variations have been provided herein, those of skill in the art will recognize certain modifications, permutations, additions and combinations and certain sub-combinations of the embodiments, aspects and variations. It is intended that the following claims are interpreted to include all such modifications, permutations, additions and combinations and certain sub-combinations of the embodiments, aspects and variations are within their scope.

What is claimed is:

1. A computer architecture to facilitate signaling between apps running on devices, the computer architecture comprising:
an SIP server, wherein the SIP server communicates under SIP protocol carried by a signal transport protocol;
an agent server;
at least one first agent instantiated on the agent server, wherein the at least one first agent is in communication with a first mobile app under a first protocol carried by a first transport protocol, and wherein the at least one first agent is in communication with the SIP server under the SIP protocol carried by the signal transport protocol; and
at least one second agent instantiated on the agent server, wherein the at least one second agent is in communication with a second app under a second protocol carried by a second transport protocol, and wherein the at least one second agent is in communication with the SIP server under the SIP protocol carried by the signal transport protocol;
wherein the at least one first agent has the capability (i) to receive a signaling message under the first protocol from the at least one first mobile app carried by the first transport protocol, (ii) to convert the signaling message into SIP protocol, (iii) to send the signaling message to the SIP server under SIP protocol carried by the signal transport protocol, (iv) to receive a responding signaling message from the SIP server under SIP protocol carried by the signal transport protocol, (v) to convert the responding signaling message into the first protocol, and (vi) to send the responding signaling message to the at least one first mobile app under the first protocol carried by the first transport protocol;
wherein the SIP server has the capability to transmit the signaling message and the responding signaling message under SIP protocol carried by the signal transport protocol between the at least one first agent and the at least one second agent; and
wherein the at least one second agent has the capability (i) to receive the signaling message from the SIP server under SIP protocol carried by the signal protocol and convert the SIP protocol of the signaling message to the second protocol, (ii) to send the signaling message to the at least one second app under the second protocol carried by the second transport protocol, and (iii) to receive the responding signaling message from the at least one second app under the second protocol carried by the second transport protocol, (iv) to convert the responding signaling message into SIP protocol, (v) to send the responding signaling message to the SIP server under SIP protocol carried by the signal transport protocol.

2. The computer architecture according to claim 1, wherein the signal transport protocol is UDP.

3. The computer architecture according to claim 1, wherein the SIP server and the agent server reside virtually in a computing cloud.

4. The computer architecture according to claim 1, wherein the first transport protocol and the second transport protocol are the same protocol.

5. The computer architecture according to claim 4, wherein the first transport protocol and the second transport protocol are TCP.

6. The computer architecture according to claim 1, wherein the agent server comprises more than one agent server, wherein each agent server is capable of instantiating a plurality of first agents and a plurality of second agents.

7. The computer architecture according to claim 1, wherein the second app is a second mobile app.

8. A method for signaling between apps running on devices to reduce load on SIP servers, the method comprising:
a. instantiating at least one first agent on an agent server, wherein the at least one first agent is capable of communicating under a first protocol carried by a first transport protocol with a first app residing on a first mobile device, wherein the first app has a first IP address, wherein the at least one first agent tracks the first IP address, and wherein the at least one first agent communicates with an SIP server under SIP protocol carried by a signal transport protocol;
b. instantiating at least one second agent on the agent server, wherein the at least one second agent is capable of communicating under a second protocol carried by a second transport protocol with a second app residing on a second device, wherein the second app has a second IP address, wherein the at least one second agent tracks the second IP address of the second app, and wherein the at least one second agent communicates with the SIP server under SIP protocol carried by the signal transport protocol;
c. receiving, by the at least one first agent from the first app, a signaling message under the first protocol carried by the first transport protocol;
d. converting, by the at least one first agent, the signaling message into SIP protocol;
e. sending, by the at least one first agent to the SIP server, the signaling message under SIP protocol carried by the signal transport protocol;
f. receiving, by the at least one second agent from the SIP server, the signaling message under SIP protocol carried by the signal transport protocol;
g. converting, by the at least one second agent, the signaling message into the second protocol;
h. sending, by the at least one second agent to the second app, the signaling message under the second protocol carried by the second transport protocol;
i. receiving, by the at least one second agent from the second app, a responding signaling message under the second protocol carried by the second transport protocol;
j. converting, by the at least one second agent, the responding signaling message into the SIP protocol;
k. sending, by the at least one second agent to the SIP server, the responding signaling message under SIP protocol carried by the signal transport protocol;
l. receiving, by the at least one first agent from the SIP server, the responding signaling message under SIP protocol carried by the signal transport protocol;
m. converting, by the at least one first agent, the responding signaling message into the first protocol;
n. sending, by the at least one first agent to the first app, the responding signaling message under the first protocol carried by the first transport protocol.
o. repeating any of steps c-n until a call is terminated.

9. The method according to claim 8, wherein the signal transport protocol is UDP.

10. The method according to claim 8, wherein the first transport protocol and the second transport protocol are the same protocol.

11. The method according to claim 8, wherein the first transport protocol and the second transport protocol are TCP.

12. The method according to claim 8, wherein the first transport protocol is TCP and the second transport protocol is UDP.

13. The method according to claim 8, wherein the second device is a second mobile device.

14. The method according to claim 8, wherein the agent server comprises more than one agent server, and wherein instantiating the at least one first agent takes place on a different agent server than instantiating the at least one second agent.

15. The method according to claim 8, wherein the first transport protocol and the second transport protocol are TCP, and the second device is a second mobile device.

16. A computer architecture to facilitate peer-to-peer audio/video calls between apps running on devices, the computer architecture comprising:
at least one first proxy residing on an agent server, wherein the at least one first proxy is assigned a first nonchanging IP address when called upon by a first app residing on a first mobile device, wherein the first app has a first IP address capable of changing, and wherein the at least one first proxy is capable of tracking the first IP address if it changes;
at least one second proxy residing on the agent server, wherein the at least one second proxy is assigned a second nonchanging IP address when called upon by a second app residing on a second device, wherein the second app has a second IP address, and wherein the at least one second proxy is capable of tracking the second IP address if it changes;
wherein the at least one first proxy and the at least one second proxy transmit audio/visual data between the first app and the second app.

17. The computer architecture according to claim 16, wherein the agent server comprises more than one agent server, and wherein the at least one first proxy resides on a different agent server from the at least one second proxy.

18. The computer architecture according to claim 17, wherein the second device is a second mobile device.

19. A method for transmitting audiovisual data between mobile apps while tracking changing IP addresses and monitoring power states of the mobile apps, the method comprising:
instantiating at least one first proxy in an agent server when the agent server is contacted by a first app residing on a first mobile device, wherein the at least one first proxy has a first fixed IP address and tracks a changing IP address of the first mobile app;
instantiating at least one second proxy in the agent server when the agent server is contacted by a second app residing on a second device, wherein the at least one second proxy has a second fixed IP address and tracks an IP address of the second device, and wherein the at least one second proxy is in communication with the at least one first proxy; and
transferring audio-visual data between the first app and the second app via the at least one first proxy and the at least one second proxy.

20. The method according to claim 19, wherein the second device a second mobile device.

21. The method according to claim 19 wherein the agent server comprises more than one agent server, and wherein instantiating the at least one first proxy takes place on a different agent server than instantiating the at least one second proxy.
